(19) United States
(12) Patent Application Publication
(10) Pub. No.: US 2006/0169054 A1
(43) Pub. Date: Aug. 3, 2006

(54) Magnetic-inductive flow meter with a measuring tube made of plastic

(76) Inventors: Dieter Keese, Wahlsburg (DE); Kathrin Zajac, Goettingen (DE); Bernd Schneider, Hardegsen (DE); Ralf Baecker, Bovenden (DE)

Correspondence Address: ABB Inc.;Legal Dept. - 4U6, 29801 Euclid Avenue, Wickliffe, OH, 44092-1832, US

(21) Appl. No.: 11/288,790

(22) Filed: Nov. 29, 2005

(30) Foreign Application Priority Data
Nov. 30, 2004 (DE) 10 2004 057 695.5

(51) Int. Cl. G01F 1/58

(52) U.S. Cl. 73/861.12

(57) ABSTRACT

The present invention relates to a magnetic-inductive flow meter with a measuring tube, which can be fitted into a pipeline system by using connecting means, with at least two measuring electrodes that are fitted into the wall of the measuring tube opposite each other in an electrically isolated manner and are intended for sensing a measuring voltage, a magnet unit, which is likewise arranged on the outside of the measuring tube, generating a magnetic field that is aligned substantially perpendicularly in relation to the direction of flow of the conductive flow medium to be measured. In order to provide here a magnetic-inductive flow meter for low-pressure applications which can be easily produced and can also be easily fitted into a pipeline system, it is proposed here according to the invention that the the measuring tube (1) is produced from a semifinished tube made of high-density polyethylene (HDPE), which can be fitted into the pipeline system (2) without any flanges.

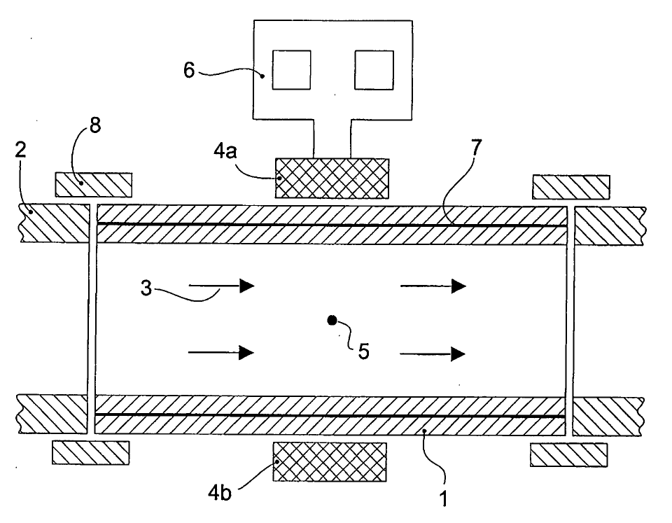

The present invention relates to a magnetic-inductive flow meter with a measuring tube, which can be fitted into a pipeline system by using connecting means, with at least two measuring electrodes that are fitted into the wall of the measuring tube opposite each other in an electrically isolated manner and are intended for sensing a measuring voltage, a magnet unit, which is likewise arranged on the outside of the measuring tube, generating a magnetic field that is aligned substantially perpendicularly in relation to the direction of flow of the conductive flow medium to be measured.

A magnetic-inductive flow meter is preferably used as a flow meter for liquids, slurries and pastes which have a specific minimum electrical conductivity. This type of flow meter is distinguished by quite accurate measuring results, without any pressure loss being caused in the pipeline system by the measurement. Furthermore, magnetic-inductive flow meters do not have any movable components or components protruding into the measuring tube, which are particularly liable to wear. The area of use of the flow meter of interest here extends primarily to applications in the chemical industry, pharmaceuticals and the cosmetics industry as well as communal water and waste-water management and the food industry.

Faraday's law of induction forms the physical basis for the measuring method of a magnetic-inductive flow meter. This natural law states that a voltage is induced in a conductor moving in a magnetic field. When this natural law is exploited in measuring technology, the electrically conductive medium flows through a measuring tube in which a magnetic field is generated perpendicularly in relation to the direction of flow. The voltage induced in the medium is picked up by an arrangement of electrodes. Since the measuring voltage obtained in this way is proportional to the average flow rate of the flowing medium, the volumetric flow of the medium can be determined from this. Taking the density of the flowing medium into account, its mass flow can be ascertained.

EP 0 869 336 A2 discloses a magnetic-inductive flow meter of the generic type. Its arrangement of electrodes interacts with two opposite solenoids, which generate the required magnetic field perpendicularly in relation to the direction of flow in the measuring tube. Within this magnetic field, each volume element of the flowing medium moving through the magnetic field, with the field strength that is present in this volume element, makes a contribution to the measuring voltage picked up by means of the measuring electrodes. The measuring voltage is fed to the input side of downstream evaluation electronics. Within the evaluation electronics, firstly a signal amplification takes place by means of an electronic differential amplifier, the differential amplifier operating here with respect to the reference potential, which usually corresponds to ground potential. On the basis of the measuring voltage, the evaluation electronics produce a value for the volumetric flow of the medium flowing through the measuring tube. The measuring tube is fastened by means of flange regions on both sides to corresponding flange ends of the pipeline system with the assistance of sealing rings and a number of screws distributed around the periphery of the flange connections.

The measuring tube of such a magnetic-inductive flow meter usually consists of a metal, in order to ensure adequate pressure stability. This is so since the pipeline system in which a flow meter is fitted is usually under pressure to make the medium flow. Customary metals are, in particular, steel, titanium, tantalum, platinum-iridium or alloys thereof and also lightweight metal, such as aluminum or alloys thereof. All these metals are sufficiently corrosion-resistant and, in particular, pressure-stable for the common applications of a magnetic-inductive flow meter. For the electric isolation of the measuring electrodes extending through the wall of the measuring tube with respect to the metallic, and to this extent conductive, measuring tube, the latter is lined. The lining in this case consists of a non-conductive material; so-called liners, that is thin-walled plastic tubes that are drawn into the metallic measuring tube, are used for this purpose.

A disadvantage here is that a measuring tube constructed in such a way requires quite high expenditure on material, if only because of the quite expensive types of metal. In addition, the drawing of the liner into the measuring tube is quite a complex technical production operation. Close dimensional tolerances have to be maintained.

On the other hand there is the recognition that, for many applications—in particular in the water and waste-water area—a measuring tube with comparatively low pressure stability would be adequate.

It is therefore the object of the present invention to provide a magnetic-inductive flow meter for low-pressure applications which can be easily produced and can also be easily fitted into a pipeline system.

The object is achieved on the basis of a magnetic-inductive flow meter according to the preamble of claim 1 together with its defining features. The dependent claims which follow present advantageous developments of the invention.

The invention includes the technical teaching that the measuring tube is produced from a semifinished tube made of high-density polyethylene (HDPE), which can be fitted into the pipeline system without any flanges.

The advantage of the solution according to the invention is, in particular, that a commercially available semifinished tube made of a special material is used for the specific application of interest here. Tests have shown that the material HDPE meets all the requirements in the low-pressure area—in particular in the water and waste-water area. The special material is distinguished by a low density with at the same time good toughness. It is consequently quite lightweight and stable. In addition, the material HDPE has very good chemical resistance, which is a necessary condition in the waste-water area in particular. The comparatively quite low operating temperature of the material HDPE of about 80° C. is also acceptable in the low-pressure area. In addition, a semifinished tube made of HDPE has a smooth inner tube surface and consequently offers virtually no contact points for abrasion. The semifinished tube is also suitable for use as a measuring tube in a magnetic-inductive flow meter because it has adequate flexibility to adapt to offset tube connections. It is unlikely to be affected by damage or brittle fracture caused by the length of its service life. The measuring tube according to the invention can be obtained in a simple way by cutting the semifinished tube to length. This is the precondition required for fitting the measuring tube obtained in this way into the pipeline system entirely without flanges.

The flange-free connection of the measuring tube to the pipeline system can preferably take place according to the following three suggestions:

Firstly, the measuring tube may be fitted into the pipeline system without any flanges by using unreleasable connecting means, in that the connection between the measuring tube and the adjoining pipeline system is configured as an integral welded connection. A precondition for a welded connection is that the material of the measuring tube and the material of the adjoining pipeline system are identical. This means that the pipeline system must also consist of HDPE. The choice of a welded connection as a connecting means ensures particularly high strength of the connecting location.

As an alternative to this, it is also possible that the measuring tube can be fitted into the pipeline system without any flanges by using releasable connecting means. One way of doing this is by using a sleeve connection. A sleeve connection presupposes that the measuring tube and the adjoining pipeline system have the same outside diameter, which can be enclosed by the connecting sleeve in a sealing manner. The connecting sleeve is usually closed by using releasable fastening means—such as screws. Furthermore, it is also conceivable to use releasable connecting means for a clamp connection for fastening the measuring tube in the pipeline system. A precondition for this is that the measuring tube can be inserted into the end of the adjoining pipeline system on both sides. Subsequently, the connecting location is placed over the insertion region and closed by using releasable connecting means—such as screws.

According to a further measure, improving the invention, the measuring tube is equipped with an integrated metal shielding, or a metal shielding arranged on the outer surface, in particular for purposes of diffusion protection against contaminants. The metal shielding may take the form here of a metal plate or a metal foil. Aluminum or alloys thereof have proven to be particularly suitable as the material for the metal plate or the metal foil. A metal shielding that is integrated directly in the metal tube can be provided in a simple way by encapsulating the hollow-cylindrical, prefabricated metal shielding with the HDPE material. The use of a metal foil leads to considerable material savings here in comparison with the use of a metal plate, while at the same time the desired function is reliably performed. In the case of an arrangement of a metal shielding on the outer surface of the measuring tube, a metal plate is to be given preference for reasons of stability. This is so since a metal plate is more resistant than a metal foil to external mechanical loads.

Apart from the diffusion protection created in this way, the metal shielding of the measuring tube of a magnetic-inductive flow meter may also be used for the electrical shielding of the electrodes. All that is required for this is that the metal shielding is electrically connected to the ground electrodes, in order to shield the useful voltage in the measuring tube from the excitation voltage generated by the magnet unit.

The most significant advantage resulting from this is that, with the measuring tube according to the invention, electrically the same functions as in the case of a metallic measuring tube can be performed, while on the other hand the benefits of simple production can also be exploited. In addition, a magnetic-inductive flow meter with the measuring tube formed according to the invention is also distinguished by itself having a comparatively low weight.

Further measures improving the invention are described in more detail below together with the description of a preferred exemplary embodiment of the invention on the basis of the single figure. The figure shows a schematic longitudinal section through a magnetic-inductive flow meter with a measuring tube made of plastic.

According to the figure, the magnetic-inductive flow meter has a measuring tube 1, which is fitted into a pipeline system 2. The measuring tube 1 is flowed through by a flowable flow medium 3 and, to conform to the magnetic-inductive flow measuring principle, the flow medium 3 has at least slight electrical conductivity. Also provided, on the outside of the measuring tube 1, is a magnet unit 4a, 4b, which comprises magnets lying opposite each other and serves for generating a magnetic field extending perpendicularly in relation to the axis of the measuring tube. The magnet unit 4a, 4b corresponds with two measuring electrodes 5 arranged lying opposite each other on the measuring tube 1 (of which only one measuring electrode can be seen in this sectional representation). The measuring electrodes 5 are aligned perpendicularly in relation to the axis of the magnetic field and serve for measuring measuring voltage induced as a consequence of the flow of the flow medium 3. The measuring signal is fed to a downstream electronics unit 6, which serves as an electrical interface with further signal-processing devices.

The measuring tube 1 is produced according to the invention from a semifinished tube made of high-density polyethylene (HDPE) and has a substantially hollow-cylindrical basic shape. For electrical shielding and as diffusion protection against contaminants, the measuring tube 1 has an integrated metal shielding 7. The metal shielding 7 in each case comprises a metal foil and is integrated in the measuring tube 1 by encapsulating it with HDPE. The metal foil consists here of aluminum. The metal shielding is electrically connected to ground electrodes—not represented any further—in order that the useful voltage in the measuring tube 1 is shielded from the excitation voltage generated by the magnet unit 4a, 4b.

The measuring tube 1 is fitted into the surrounding pipeline system 2 without any flanges. For the connection between the measuring tube 1 and the adjoining pipeline system 2 of the same diameter, a sleeve connection 8 is used here, by which the measuring tube 1 is releasably installed in the pipeline system 2.

1-8. (canceled)

9. A magnetic-inductive flow meter for flangeless fitting into a pipeline system comprising:
a measuring tube produced from a semi-finished tube made of high-density polyethylene (HDPE), said measuring tube comprising with at least two measuring electrodes that are fitted into a wall of said measuring tube opposite each other in an electrically isolated manner, said at least two measuring electrodes for sensing a measuring voltage; and
a magnet unit arranged on the outside of the measuring tube, said magnet unit generating a magnetic field that is aligned substantially perpendicularly in relation to the direction of flow through said measuring tube of a conductive flow medium to be measured.

10. The magnetic-inductive flow meter of claim 9 further comprising means for flangelessly fitting said flow meter into said pipeline system.

11. The magnetic-inductive flow meter of claim 10 wherein said means for flangelessly fitting said flow meter into said pipeline system is an unreleasable connecting means.

12. The magnetic-inductive flow meter of claim 10 wherein said means for flangelessly fitting said flow meter into said pipeline system is a releasable connecting means.

13. The magnetic-inductive flow meter of claim 12 wherein said measuring tube and said pipeline system have the same outer diameter and said releasable connecting means is a sleeve connection.

14. The magnetic-inductive flow meter of claim 12 wherein said releasable connecting means is a clamp connection when said measuring tube is fitted into said pipeline system.

15. The magnetic-inductive flow meter of claim 9 wherein said measuring tube further comprises either an integral metal shielding or a metal shielding arranged on the outer surface of said measuring tube.

16. The magnetic-inductive flow meter of claim 15 wherein said metal shielding arranged on the outer surface of said measuring tube is either a metal plate or a metal foil.

17. The magnetic-inductive flow meter of claim 16 wherein said metal plate or said metal foil consists of aluminium of alloys thereof.

18. The magnetic-inductive flow meter of claim 15 wherein said metal shielding arranged on the outer surface of said measuring tube is electrically connected to grounds electrodes.

19. The magnetic-inductive flow meter of claim 16 wherein said metal shielding arranged on the outer surface of said measuring tube is electrically connected to grounds electrodes.

20. The magnetic-inductive flow meter of claim 17 wherein said metal shielding arranged on the outer surface of said measuring tube is electrically connected to grounds electrodes.

21. A method for making and using a magnetic-inductive flow meter for flangeless fitting into a pipeline system comprising:
producing a measuring tube from a semi-finished tube made of high-density polyethylene (HDPE), said measuring tube comprising with at least two measuring electrodes that are fitted into a wall of said measuring tube opposite each other in an electrically isolated manner, said at least two measuring electrodes for sensing a measuring voltage.

22. The method of claim 21 further comprising:
arranging a magnet unit on the outside of the measuring tube, said magnet unit generating a magnetic field that is aligned substantially perpendicularly in relation to the direction of flow through said measuring tube of a conductive flow medium to be measured.

23. The method of claim 21 further comprising:
flangelessly fitting said flow meter to said pipeline system.

24. The method of claim 23 further comprising unreleasably flangelessly fitting said flow meter to said pipeline system.

25. The method of claim 23 further comprising releasably flangelessly fitting said flow meter to said pipeline system when said measuring tube and said pipeline system have the same outside diameter.

26. The method of claim 23 further comprising releasably flangelessly fitting said flow meter to said pipeline system by fitting said measuring tube into said pipeline system.
